(19) United States
(12) Patent Application Publication
(10) Pub. No.: US 2007/0126716 A1
(43) Pub. Date: Jun. 7, 2007

(54) DIGITAL PEN

(76) Inventor: Jonathan Haverly, North Easton, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/561,221

(22) Filed: Nov. 17, 2006

Related U.S. Application Data
(60) Provisional application No. 60/597,237, filed on Nov. 17, 2005.

(51) Int. Cl. G09G 5/00

(52) U.S. Cl. 345/179

(57) ABSTRACT

A handheld writing instrument achieves digital positioning capabilities in a compact form factor by incorporating passive fiducials such as RFID tags into the body of the writing instrument. By positioning the fiducials in known locations relative to the writing tip, an active sensing system outside of the pen can remotely stimulate the passive fiducials and gather distance and/or position data for locating the writing tip.

### RELATED APPLICATIONS

This application claims the benefit of commonly-owned U.S. application Ser. No. 60/597,237 filed on Nov. 17, 2005 and entitled “Method and system for the real-time electronic capture of handwritten annotations with a stylus, pen or other writing implement utilizing electromagnetic sensors in combination with Radio Frequency Identification transmitters and readers”, the entire contents of which is incorporated herein by reference.

### BACKGROUND

1. Field of the Invention

This invention relates to a system for electronically capturing handwritten annotations from a writing device such as a pen by inferring the position of a writing tip (or erasing tip) from the location of passive fiducials associated with the writing device.

2. Related Art

The digitization of handwriting has been pursued for years with many solutions in existence today.

Some current solutions employ a special purpose writing surface to detect the movement of a pen tip along the surface. For example, U.S. Pat. No. 5,623,129 discloses a penetrable x-ray or infrared field above a writing surface. Other well-known solutions incorporate touch-sensitive surfaces using, e.g., capacitive, resistive, or other touch-screen technologies.

Other solutions employ an active pen device that provides independent detection of contact between a pen tip and a writing surface. For example, one technique directly tracks and digitizes motion of a ball in a ball point pen.

Other solutions employ various combinations of discrete position sensing and pen motion detection to actively track pen position, from which the position of the pen's writing tip can be inferred. In general, these solutions employ active transmitters within the pen itself. For example, U.S. Pat. Pub. No. US 2003/0071754 discloses a pen with two RF transmitters that send a periodic, characteristic “burst” of RF code. The detected transmitter locations are used to determine orientation and pen tip location. Other implementations such as U.S. Pat. No. 6,348,914 discloses a pen with a number of ultrasound emitters. Still other solutions track pen motion using, e.g., inertial detection that can be converted into pen and writing tip location data.

While the extensive prior art in this field demonstrates a long felt need for a solution to the problem of simultaneous physical and digital recording of written material, and the existing solutions seem to provide adequate digital detection of pen tip position, the existing solutions have not achieved broad commercial success. This is likely due to a variety of factors including technical complexity, cost, unsuitability for concurrent use with paper-based writing, and an inability to package active components within a conventionally shaped and sized pen body.

There remains a need for an improved writing device capable of digitally recording physical markings while retaining the look, feel, and function of an ordinary pen.

### SUMMARY

A handheld writing instrument achieves digital positioning capabilities in a compact form factor by incorporating passive fiducials such as RFID tags into the body of the writing instrument. By positioning the fiducials in known locations relative to the writing tip, an active sensing system outside of the pen can remotely stimulate the passive fiducials and gather distance and/or position data for locating the writing tip.

In one aspect, a device disclosed herein includes a body formed as a hand-held writing implement, the body including a writing tip adapted to mark a surface with a physical marking; and a plurality of passive devices within the body, each one of the plurality of passive devices having a known location relative to the writing tip, and each one of the plurality of passive devices providing a characteristic signal in response to a predetermined external stimulus, the characteristic signal suitable for determining a location of the one of the plurality of passive devices.

The device may further include a power source separate from the body that provides the predetermined external stimulus as an electromagnetic field that remotely powers the plurality of passive devices. The characteristic signal of each one of the plurality of passive devices may include a unique electromagnetic signature. The characteristic signal of each one of the plurality of passive devices may include an acoustic signature. The device may include one or more remote sensors that detect the characteristic signals from the plurality of passive devices to provide sensor data. The device may include a processor configured to receive the sensor data and determine a plurality of distances from the one or more remote sensors to the plurality of passive devices, the processor further configured to calculate a position of the writing tip. The device may include a processor adapted to receive the sensor data and determine a position and orientation of the body. The one or more remote sensors may include an RFID reader. The body may include an erasing tip on an opposing end of the body to the writing tip, the erasing tip adapted to remove the physical marking. The plurality of passive devices may include at least one passive RFID tag. The device may include an ink reservoir coupled to the writing tip to distribute ink for the physical marking. The writing tip may include a ball point pen tip. The writing tip may include a pencil tip. The passive devices may be removably connected to the body. Each characteristic signal may encode one or more of a distance from the writing tip, a distance from a centerline of the body, a distance from an opposing tip of the body, a code specifying whether an associated one of the passive devices is nearer to the writing tip of the opposing tip, and a unique identification code. One or more of the plurality of passive devices may include an associated memory.

In another aspect, a system disclosed herein may include a writing surface; a plurality of sensors arranged about the writing surface, each sensor adapted to receive a signal from one or more of a plurality of passive devices having a known location relative to a writing tip of a writing instrument, and to provide sensor data indicative of a distance to the one or more of the plurality of devices; and a processor coupled to the plurality of sensors, the processor configured to receive the sensor data and to calculate therefrom a location of the writing tip, and the processor further configured to digitally record a position of the writing tip when the writing tip is substantially in the plane of the writing surface.

The system may include a remote power source that stimulates one or more of the passive devices to transmit a characteristic signal. The system may include a memory to store the position of the writing tip when the writing tip is substantially in the plane of the writing surface. The system may include one or more thickness sensors to measure a thickness of an object placed on the writing surface. The processor may account for the thickness of the object when determining whether the writing tip is substantially in the plane of the writing surface. The passive devices may include passive RFID tags and the sensors include an RFID reader. The system may include a hand-held writing implement adapted to mark a surface with a physical marking, the hand-held writing implement containing the writing tip and the plurality of passive devices.

In another aspect, a system described herein includes a plurality of passive devices adapted to be removably and replaceably attached to an exterior of a hand-held writing implement that includes a writing tip adapted to mark a surface with a physical marking, each one of the plurality of passive devices having a known location relative to the writing tip, and each one of the plurality of passive devices providing a characteristic signal in response to a predetermined external stimulus, the characteristic signal suitable for determining a location of the one of the plurality of passive devices.

The hand-held writing implement may include a ball point pen. The hand-held writing implement may include a mechanical pencil.

### BRIEF DESCRIPTION OF THE DRAWINGS

FIG. 1 is a side perspective view of the digital pen system.

FIG. 2 is a side elevation view of one embodiment of the device.

FIG. 3 is a side perspective view of one embodiment of the sensor system.

FIG. 4 is a side perspective view of one embodiment of the device and the sensor system illustrating one implementation for calculating the location and position of the device.

FIG. 5 is a side perspective view of another embodiment of the digital pen system.

FIG. 6 is a side elevation view of another embodiment of the device.

### DETAILED DESCRIPTION

A digital pen system will now be described in detail with reference to the accompanying drawings. It will be appreciated that, while the following description focuses on a digital pen that writes on paper with ink, the systems and methods disclosed herein have wide applicability. For example, the techniques described herein may be readily employed with mechanical pencils on paper, or erasable markers on a white board. In addition the use of compact, passive fiducials for measuring the location of a handheld device may have utility in other small devices such as a stylus, pointer, paintbrush, and the like. All such variations and modifications that would be envisioned by one of ordinary skill in the art are intended to fall within the scope of this disclosure.

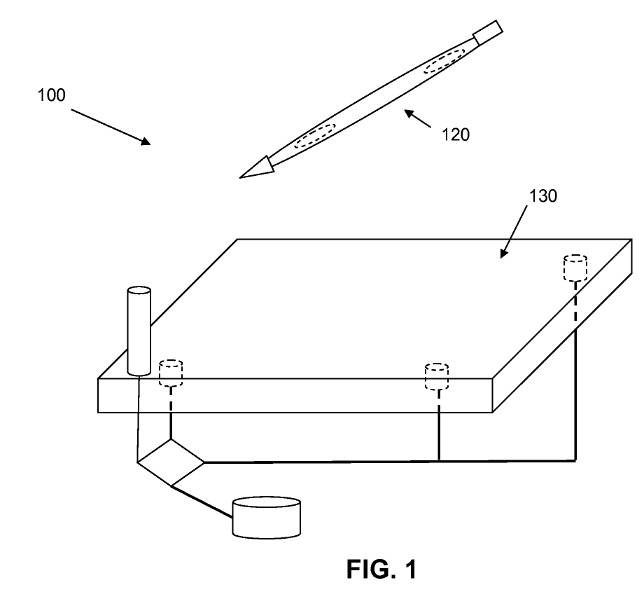

As shown in FIG. 1, an embodiment of the digital pen system 100 includes a device 120 and a sensor system 130 for sensing and processing signals generated from the device 120.

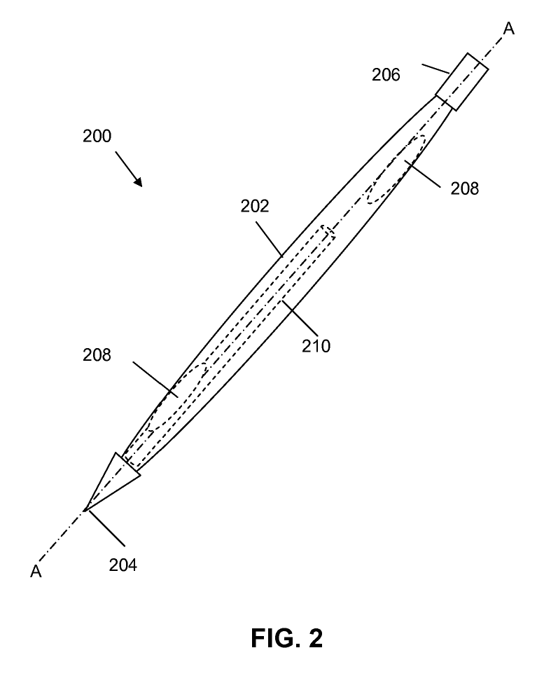

An embodiment of a device 200 is shown in FIG. 2. The device 200 may include a body 202 shaped as a hand-held writing implement with a writing tip 204 and an opposing end 206. The centerline of the body 202 in FIG. 2 is represented by dashed line A-A. The body 202 may also include one or more passive devices 208 or fiducials used in the positioning systems described below.

The body 202 may be of any shape that allows manipulation of the device 200 for marking. In one embodiment, the body 202 may be shaped and sized as a writing implement such as a pen, pencil, or marker. The form factor may include without limitation a ball point pen, a fountain pen, a mechanical pencil, a felt tip maker, a pen with a retractable tip, a pen with a cap, and so forth. The body 202 may be made from any material having sufficient rigidity to function as a writing device and to hold portions of the body 202 in a constant position relative to one another in a manner that supports location determination using the systems and methods described herein. Materials for the body 202 may consist of, but need not be limited to, plastics, woods and metals, and combinations thereof.

The body 202 may include the writing tip 204 and the opposing end 206. In general, the writing tip 204 is an extremity of the body 202 that serves to physically mark a surface using, e.g., a pencil lead, dyed wax, ink, or the like. As used herein, the term “writing tip” may also refer to the specific two-dimensional or three-dimensional location recorded by the sensor system disclosed herein, and both such meanings are intended unless a specific meaning is specifically indicated or otherwise clear from the context. The body 202 may also include an opposing end 206 which may serve an auxiliary function in a writing implement such as an eraser, a different-colored ink, or a different type of physical marking. In other embodiments, the opposing end 206 may provide other functions useful in a digital recording context, such as familiar computer drawing tools including an eraser, a paint brush, a paint sprayer, a stamp, and so forth.

The device 200 may include a number of passive devices 208 or fiducials affixed to the body 202. In general, these fiducials can serve as reference points or landmarks that may be readily located by a corresponding sensing technology. In one embodiment described below, passive radio frequency identification (“RFID”) tags are employed as electromagnetic fiducials. While this approach builds on a readily available and inexpensive technology, other passive fiducials are known in the art and may be similarly employed with the systems described herein including x-ray fiducials, ultrasound or other acoustic fiducials, infrared fiducials, optical fiducials, magnetic fiducials, and so forth. These and other similar techniques may be employed with the systems described herein provided the passive devices can be incorporated into the body of a conventionally shaped and sized pen or other writing implement, and can be located with suitable accuracy to determine a position of the writing tip 204 (or opposing end 206) thereof.

Each passive device 208 or fiducial may be placed in a known location on the body 202 relative to the writing tip 204 and/or the opposing end 206. In the depicted embodiment, the passive devices 208 are integrated into the body, however, in other embodiments, the devices 208 may be incorporated into a removable and replaceable cover or clip that fits over a conventional writing implement. The passive devices 208 may, for example, be integrated into the plastic walls of a common plastic pen. In general, the passive devices 208 may be attached to an exterior of the body 202, attached to a hollow interior of the body 202, physically integrated into the material(s) that form the body 202, or removably attached to an exterior of the body 202, or some combination of these.

Each passive device 208 or fiducial may be positioned to facilitate location of the writing tip 204 and/or the opposing end 206. In one embodiment, two passive devices 208 may be positioned coaxially within the pen body 202. While this may require certain modifications to the pen such as repositioning an ink reservoir 210, or alternatively positioning the passive device 208 within an ink reservoir, this arrangement advantageously avoids ambiguity with respect to a position of the writing tip 204. In another embodiment, the passive device 208 may be positioned off axis, such as equidistantly on either side of a centerline A-A of the body 202 and in the same relative plane to each other. In such embodiments, a third fiducial, or some other technique may also be usefully employed for resolving ambiguity in the calculated position of the writing tip 204. Other placements of the passive devices 208 are possible provided the placement may be used by sensing systems described herein to accurately calculate the position and orientation of the device 200, and more specifically the position of the writing tip 204 and/or the opposing end 206.

In general, the passive devices 208 or fiducials may be adapted to provide a characteristic signal in response to an externally applied field or other stimulus. The characteristic signal may allow sensors to receive sensor data useful for determining the location of the passive devices 208, and based upon their known relative locations, the writing tip 204 and/or opposing tip 206. In an embodiment, one or more of the passive devices 208 is capable of providing a characteristic signal that may be used to uniquely identify that particular device among a plurality of devices 208. Each of the passive devices 208 may emit this signature at a predetermined frequency and power level depending on the design and implementation of the device and the corresponding sensing technology.

It will be understood that the term “passive” as used herein denotes a device that does not include a power source such as an internal battery or physical cabling to an external power source. Thus, a passive RFID tag may be a passive device or passive fiducial within the meaning of this specification, and is specifically intended to fall within the scope of the passive devices described herein, even though a conventional RFID tag contains active electronics that are stimulated by an ambient electromagnetic field. In the case of RFID tags which are able to power themselves using a remotely supplied electromagnetic field (such as from an RFID reader), a small memory may also be provided. The memory may store any relevant data including without limitation a position of the device within the body 202 including distance from the center line A-A, distance from the writing tip 204, distance from the opposing tip 206, a code identifying which tip 204, 206 is nearer to the device, a unique identification code for the device, a manufacturer code, a model number, a UPC number, a color code, a date of manufacture code, an expiration date code, or any other useful information. In certain embodiments, the unique identification code may be selected to create a characteristic signal that assists in distance determinations using techniques known in the art.

In one embodiment, the passive devices 208 may include passive RFID tags powered by external sources such as an RFID reader. A number of advantages may be realized from this compact, inexpensive, readily available technology. RFID tags have a size that may be readily integrated into the form factor of a conventional writing implement such as a ball point pen, a pencil or the like. Further, by using passive RFID devices, the writing device 200 may dispense with an internal power source such as a battery and/or a physical coupling to an external power source such as a power cable. While RFID tags provide one convenient embodiment, other passive fiducials 208 are known in the art and may be similarly employed with the systems described herein including x-ray fiducials, ultrasound fiducials, infrared fiducials, optical fiducials, magnetic fiducials, acoustic fiducials and so forth.

In an embodiment, information such as the location of each passive device relative to the writing tip 204 or opposing tip 206 may be determined through a calibration or setup process executed by an external processor, such as the processor(s) associated with the sensing system. Such calibration techniques are well known in the art and generally involve a placement of the writing tip 204 in one or more known locations while the processor collects location or distance data from the passive devices 208.

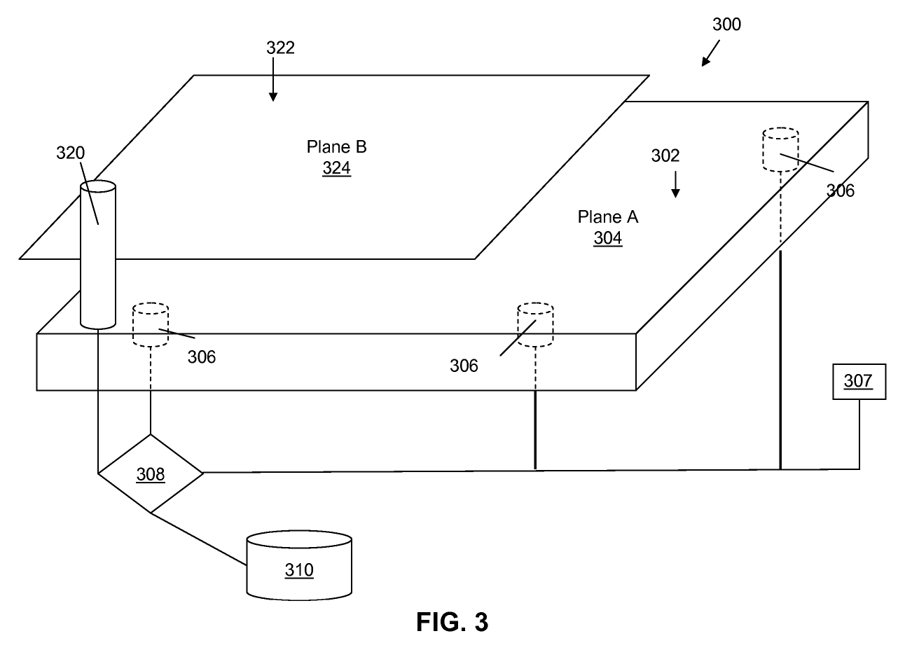

FIG. 3 depicts a sensor system 300 that may be used with the systems described herein. The sensor system 300 may include a writing surface 302 in a Plane A 304, one or more sensors 306, a processor 308 and a memory 310.

In one embodiment, the writing surface 302 may be a substantially planar material creating a two-dimensional Plane A 304. For purposes of description and not of limitation, Plane A 304 may include an X-axis and a Y-axis within a three-dimensional space about the sensing system. The axis extending above and below Plane A 304 may represent a Z-axis of the three-dimensional space, to collectively define a three-dimensional coordinate system for the sensor system.

Two or more sensors 306 may be incorporated into the sensing system 300. In general, the sensors 306 have the capacity to interrogate fiducials such as the passive devices 208 described above. The sensors 306, or a separate stimulation source 307, may emit energy that stimulates the passive fiducials. The sensors 306 may receive energy transmitted, reflected, refracted, or otherwise transformed or emitted by one or more of the fiducials. As noted above, radio frequency identification (“RFID”) readers may be employed as the sensors 306 and/or stimulation source 307. Other sensors are known in the art and may also, or instead, be usefully employed including without limitation x-ray sensors, ultrasound sensors, infrared sensors, optical sensors, magnetic sensors, acoustic sensors and so forth. These and other similar techniques may be employed with the systems described herein provided the resulting sensor system is capable of tracking fiducial positions (or motion) with adequate accuracy to usefully determine tip position of a writing implement.

The sensors 306 may be placed at known locations relative to the writing surface 302. As depicted in FIG. 3, the sensors 306 are fixed within the writing surface 302, which may form a tablet or other writing surface. However in other embodiments the sensors 306 may be placed in any location that can be determined relative to other sensors and/or the writing surface 302. The system may be adapted to self-discover sensor locations in a pre-operation calibration or discovery step.

The sensors 306 may be connected to and communicate sensor data with a processor 308 that may use sensor data (such as distance to one or more of the fiducials) to resolve a position of an instrument writing tip. In one embodiment, the processor 308 may include a memory that stores one or more predetermined sensor locations resulting from, e.g., a factory calibration or manufacturing step. In another embodiment, the processor 308 may initiate a sensor location process using techniques known in the art each time the system is powered up.

The processor 308 may also, or instead, calculate the location of the writing surface 302 from the sensors 306 and sensor data. The processor 308 may receive sensor data and perform calculations that locate the sensors 306, the writing surface 302 and/or the Plane A 304. The sensors 306 may be in the same plane as the writing surface 302. In one aspect, the sensors 306 in cooperation with the processor 308 may establish a coordinate system for subsequent location calculations. To assist in this process, the sensors 306 and the writing surface 302 may be placed in fixed, predetermine positions. For example, the sensors may be positioned within the writing surface 302, beneath the writing surface, alongside the writing surface, or elsewhere, as well as various combinations of these, and as noted above, the sensor 306 positions may be predetermined, or may be measured when the system is powered on.

As noted above, a variety of sensor technologies may be employed. The stimulation of fiducials may include stimulation with an RFID reader to create responsive RFID tag communications, or stimulation with an ultrasound device that produces a characteristic echo. In each case, the processor 308 may receive sensor data and calculate pen tip location, either through direct calculations or by determining the distances between one or more of the sensors 306 and one or more of the fiducials, and using this data in turn to calculate pen tip location. More generally, the processor 308 may provide various system functions including, e.g., calibration, setup, location of sensors, initiation of motion detection, control of sensors and stimulus devices, and processing of any resulting sensor data.

It will be appreciated that the systems and methods disclosed herein may generally be realized in hardware, software, or any combination of these suitable for the three-dimensional location techniques described herein. The process may be realized in one or more microprocessors, microcontrollers, embedded microcontrollers, programmable digital signal processors or other programmable device, along with internal and/or external memory. The process may also, or instead, include an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across the sensors and any one or more supporting processors or co-processors in a number of ways, or all of the functionality may be integrated into a dedicated, standalone device. All such permutations and combinations are intended to fall within the scope of the present disclosure, and all such embodiments are specifically intended to fall within the scope of the term “processor” as used herein.

Notwithstanding the specific embodiments discussed herein, it will be also appreciated that numerous sensing technologies, processing hardware, and three-dimensional location techniques are known in the art, and any such techniques that can be suitably employed with the systems described herein to support pen tip location are intended to fall within the scope of this disclosure.

As noted above, the fiducials may encode various data that can be transmitted in response to an external stimulus, such as unique identifiers for fiducials and the like. The processor 308 may receive this additional sensor data, and performing calculations based upon the encoded data. In an embodiment incorporating passive fiducials, signal data collected and passed by the sensor 306 may include but is not limited to the unique characteristics of the passive fiducial, the location of the passive fiducial relative to other locations, the angle of the fiducial relative to the sensor, the strength of the signal from the passive fiducial, distance data and/or any other data, and other data that assists in determining the location of the sensors 306 and the passive fiducials relative to that particular sensor 306 and the writing surface 302 such as Plane A 304.

The processor 308 may stored data including the serially collected sensor data and any calculation results in a memory 310, which may include without limitation, flash memory, random access memory, dynamic random access memory, a disk drive, a tape drive, an optical drive, or any other volatile or non-volatile memory suitable for use with the systems described herein.

As illustrated in FIG. 3, the writing surface 302 may be adapted to hold an object 322 such as a piece of paper or a pad of paper. For embodiments where object 322 is placed on top of the writing surface 302, the sensor system 300 may also include a thickness sensor 320 to detect the thickness of the object 322. The processor 308 may receive thickness data from the thickness sensor 320 calculate a position of an upper surface of the object 322. This new writing surface is shown in FIG.3 as Plane B 324, and may be used by the processor 308 to determine when a tip of a writing instrument is actually in contact with the object 322 in such a manner as to leave physical markings. The object 322 may be secured to the writing surface 302 using any conventional means including without limitation binder clips, a spring clip, tape, adhesive backing, adhesive strips, staples, paper clips, and the like, as well as various combinations of the foregoing. In other embodiments, the writing surface 302 may also, or instead, include a raised perimeter dimensioned to hold a pad (e.g., 8.5 inches by 11 inches) by surrounding the perimeter of the pad and preventing the pad from moving in the x or y axes of the plane 304.

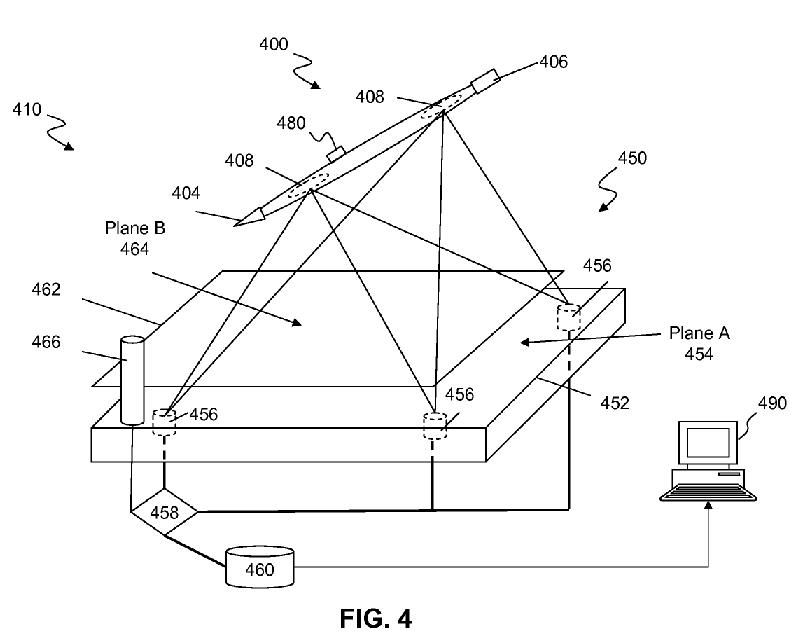

FIG. 4 provides a figurative representation of the operation of a writing device 400 with a sensor system 450. The system 410 may include the writing device 400, which contains a writing tip 404, an opposing tip 406, a first passive device 408 and a second passive device 409, which may include any of the corresponding elements described above. The sensor system 450 may include a writing surface 452 having a top plane 454, a plurality of sensors 455, 456, 457, a processor 458, a memory 460, an object 462 including a top plane 464, and a thickness sensor 466, any of which may include any of the corresponding elements described above with reference to FIGS. 1-3.

In general operation, a user holds the writing device 400, and manipulates the writing device 400 to place physical marking such as handwriting on the object 462. The sensor system 450 tracks position of the writing device 400 during these interactions, and digitally records positions of the writing tip 404 while the writing tip 404 is in contact with the object 462.

In greater detail, a user may grip the writing device 400 using the body 404. As the device 400 is brought in proximity to the system 450 and its writing surface 452 and Plane A 454, the sensors 456 (one or more of which may include a separate stimulation source) stimulate the passive fiducials 408 within the writing device 400. Once stimulated sufficiently, each of the passive fiducials 408 may emit a unique signature, such as an ultrasound echo or an RFID code, which is received by the sensors 456. Where each passive fiducial 408 has a unique signature, each fiducial 408 may be uniquely distinguished by the sensors 456, and corresponding sensor data may include a distance measurement (or other data that encodes distance) along with an identification of the corresponding fiducial 408, all of which may be used to determine location data for the fiducials.

It will be understood that location data may be derived from sensor data in various ways including signal strength, signal phase, time of flight (e.g., from stimulus to response) and so forth. In various embodiments, location data may be obtained by comparing results from a number of sensors, or by using individual, discrete sensor measurements. It will also be understood that location data, as used herein, refers to any data that encodes location information. Thus sensors may individually contain processing capability to convert received signals into distance or other data, or raw sensor data may be digitized and transmitted to the processor 458 for calculations of distance and/or location.

The processor 458 may use the location data to calculate the position of the passive fiducials 408 through mathematical calculations such as triangulation, trilateration or multilateration. For description purposes, and not for limitation, one embodiment will be described that uses triangulation calculations on location data that determines the distance between two points such as a sensor 456 and a passive fiducial 408.

As depicted generally by a number of lines in FIG. 4, each passive fiducial 408 may emit a characteristic signal that may be detected by each one of the sensors 456. Each such detection may, according to various techniques, be converted into a distance between one of the sensors and one of the fiducials. This location data may be obtained directly through an individual sensor measurement (using, e.g., an ultrasound pulse and echo), or through a combination of sensor measurements such as a comparison of relative signal strengths or phase delays among the group of sensors 456 from a single one of the fiducials 408.

In one embodiment, location data may be obtained based upon attenuation of the signal emitted from the passive fiducials 408. A passive RFID tag signal decreases at a known relationship to the distance between the fiducial 408 and the sensor 456. The power of the fiducial's signal may be measured at the sensor 456 and included as location data for the fiducial 408. Knowing the power of the passive fiducial 408 at the source of the signal and comparing that value to the received signal at the sensor 456, the signal loss may be determined and used to calculate the distance between the fiducial 408 and the sensor 456.

The system 410 may also, or instead, use time-of-flight calculations such as the round trip time for an ultrasound stimulus and echo from one of the fiducials. This may be directly converted into distance measurements between respective ones of the sensors 456 and fiducials 408 to obtain location data.

Other embodiments may employ phase information to calculate location or distance information based upon phase differences. For example, a signal may be simultaneously detected at two or more sensors, and a comparison of phase information may be employed to resolve distance or location information. In another embodiment, a single fiducial 408 may emit multiple frequencies, or each fiducial 408 may emit a different frequency. If these signals have a known relative phase relationship when transmitted, then changes to this phase relationship at one or more sensors 456 may be used to resolve distance information.

In another embodiment, location data may be obtained using sensors 456 that can detect directional information from the passive fiducials 408. Directional information for a particular fiducial 408 may be obtained at a number of sensor locations and resolved into a three-dimensional location for the fiducial 408 by the processor 458. RFID radar sensors may be employed in this context.

However obtained, the processor 458 may apply location data obtained from the sensors 456, along with known location data such as sensor positions, relative positions of fiducials 408 to the writing tip 404, and so forth to calculate a position within the sensor coordinate system for the writing tip 404. When this position falls within the plane 464 of the object 462 (e.g., paper), the processor 458 may record a position of the tip as a digital record of associated writing.

It will be understood by one of ordinary skill in the art that while two fiducials 408 and three sensors 456 are depicted, embodiments with more or fewer sensors 456 and passive fiducials 408 are possible. In addition, while some of the embodiments described above reflects a device with known locations of the passive fiducials 408 in relation to device elements such as the writing tip 404 and the opposing end 406, the system may also be configured to have the sensors 456 and the processor 458 perform calibration calculations that determine the positional relationship of the passive fiducials 408 and device elements such as the writing tip 404. One such embodiment includes having predetermined points located on the writing surface 452 for placement of the writing tip 404 as well as predetermined positions of the device 200 on the writing surface 452. Taking the location data from the passive fiducials 408 at these known points may provide sufficient data to calculate the location of the passive fiducials 408 in relation to the writing tip 404 and the opposing end 406.

In general operation, as the user moves the device 400 on the writing surface 452, the sensors 456 continuously stimulate and collect data, including location data, from the passive fiducials 408. The processor 458 continues to use that data to calculate the location of the fiducials 408. The processor 458 is able to calculate the X, Y and Z position of the passive fiducials 408 in a global coordinate system and calculate the position and orientation of the device 400 and the writing tip 404. This sensing may be performed in real time, with data captured at sufficient time intervals to allow the capture of an accurate digital record of movements of the writing tip 404 across the writing surface 452, or the object 462 positioned thereon.

In one embodiment, the location of Plane A 454 is known by processor 458 through methods also described herein. The processor 458 is able to compare the location of the passive fiducials 408 to the location of Plane A 454. Through this comparison, the processor 458 may recognize the location of the writing tip 404 or the opposing end 406 in relation to the writing surface 452 and Plane A 454. By recognizing the instances where the writing tip 404 coincides with Plane A 454, the processor 458 may create graphical representations of the writing tip 404 on the writing surface 452. This representation may reflect the marks that a tip with a marking device, like a pen with ink, would make on a writing surface such as a piece of paper.

It will be further appreciated that the digitized input may be processed in any number of ways. For example, the writing may be processed using optical character recognition to extract ASCII text or the like from the digitized input. This may in turn be provided to a computer or the like for subsequent processing. Similarly, the writing may be processed to extract shapes or other objects, to straighten lines, and so forth, either automatically or under user control. The results may be displayed, for example, on a computer monitor or the like, either in the original digitized form or in their processed (e.g., ASCII and/or object/shape) form. In other embodiments, the object 462 may include a printed form including boxes and lines for information such as a name, address, social security number, and the like, including without limitation any information that might be requested in any type of form. A user may fill out a paper copy of the form while the processor 458 extracts text from the digitized user input and associates the form data with corresponding data entry fields. Thus in one aspect there is disclosed herein a technique for concurrent paper-based and computer-based data collection which is adapted to gather computerized data from human hand writing. It will be understood that numerous applications of such a system may be devised. For example, the system may be usefully employed in a job application process, a registration process (e.g., for a class or an educational program), a survey, or any other context where handwritten data is gathered from one or more people. In other embodiments, various regions of the writing surface 452 may correspond to different navigation functions such as entering a page number, selecting a page number to retrieve previously stored data, or navigating among a number of pages. Similarly, various regions of the writing surface 452 may correspond to various drawings tools in a manner similar to a drawing environment of a graphical user interface. That is, the user may select from tools such as an eraser, a pen tip shape, or a palette of colors. While these selections may not correspond to a physical change in the writing tip of the pen, the may be used to select from a variety of drawing tools for the digitized input corresponding to the physical markings.

In another aspect, an input 480 such as a button, dial, or the like may be provided with the writing instrument 400. The input 480 provides a mechanism for a user to control operation of the writing instrument 400 in any suitable manner. For example, the input 480 may be a button that allows a user to select and deselect an eraser. In order to maintain the passive nature of the device, the input 480 may be constructed as a switch to physically disable operation of an auxiliary RFID tag within the writing device 480, or to physically set and unset a control bit or word in code transmitted by the RFID tag when activated.

Further illustrating the system in operation, as the user takes the device 400 and places the writing tip 404 on Plane A 454, the processor 458 recognizes that the writing tip 404 is in Plane A 454 and begins to create a graphical representation of the writing tip 404 as it coincides with Plane A 454. If the device 400 includes a marking tip such as a pencil tip or a ball point pen tip, the graphical representation may correspond to physical markings of the device 400 on the writing surface 452. Stored data and/or graphical representations may be retrieved from the memory 460 by the processor 458 to recreate an earlier session and allow the user to further contribute to and edit information stored in that earlier session.

For example, in operation, the user may have an earlier session with the sensor system that is stored in memory 460. A user interface may be provided that allows the user to access the earlier session from the memory 460 and edit that session. When completed with the edits, the user may store the new session in memory. The input may be transmitted to an auxiliary computer 490 (including, e.g., storage, a processor, a display, a network connection, a printer, and so forth) for further use and manipulation.

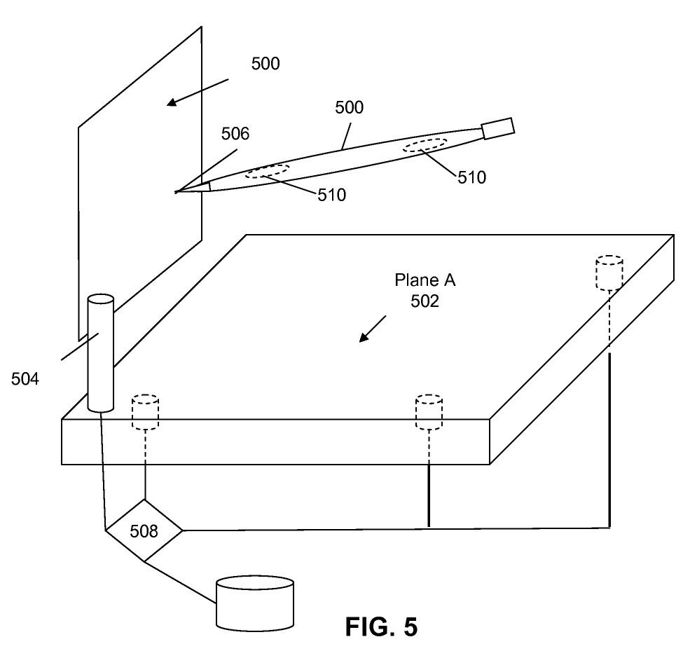

FIG. 5 shows a system with a separate writing surface plane 500. The plane 500 may be removed from the writing surface and need not be parallel to the plane 502 that houses the sensors. In one aspect, the plane 500 may simply be a notepad or paper attached to a wall, or a whiteboard, blackboard, or the like. In other aspect, the plane 500 may incorporate active display features. For example, the plane 500 may include a projection screen, a TV screen, a computer screen or other type of display. The sensors 504 may be used to recognize the location of plane 500 and therefore allow the processor 508 to calculate an engagement of the writing tip 506 with this new plane 500. One or more sensors 504 may detect a position, size, and/or orientation of the plane 500 so that the processor 508 can determine when the writing tip 506 is in contact with the plane 500. In other embodiments, the plane 500 may be fixedly attached to the original plane 502 so that relative positions of the sensors to the plane 500 are known a priori. Thus it will be understood that there is generally disclosed herein an input device that may be used in combination with a desktop computer, laptop computer, television, projector, or any other display to provide user input to an associated computing system.

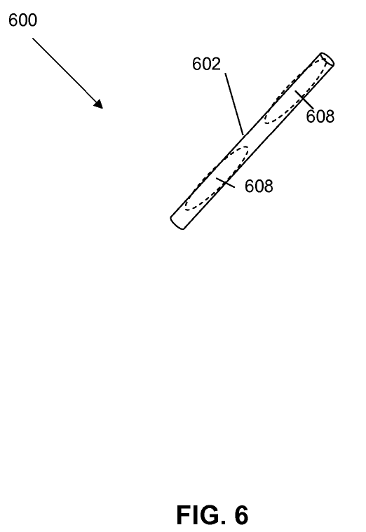

FIG. 6 shows a number of passive devices integrated into a removable clip. A mount 600 may include a body 602 and a plurality of passive devices 608. The passive devices may be any of the passive devices or fiducials described above. The body 602 may be shaped and sized to be removably and replaceably attach to a writing instrument such as any of the writing instruments described above. The mode of attachment may employ springs, flexible segments, clips, pins, friction fits, and any other suitable mechanical features. The mount 600 may be added and removed from a writing implement. The body 602 of the mount 600 may, for example, snap around an exterior of the writing instrument, or the body 602 may be formed as a sleeve or tactile grip that slides about the exterior of a writing instrument in frictional engagement therewith. In other embodiments, the mount 600 may be shaped and sized as an ink cartridge (including ink and a ball point pen or other dispenser) that can be inserted into and removed from a suitably adapted pen. The passive devices 608 may be located in fixed, known positions relative to a writing tip (if present, as in the case of certain ink cartridges). Or this relationship may be determined during one of the calibration steps described above.

While the invention has been disclosed in connection with certain preferred embodiments, other embodiments will be recognized by those of ordinary skill in the art, and all such variations, modifications, and substitutions are intended to fall within the scope of this disclosure. Thus, the inventions disclosed herein are to be understood in the broadest sense allowable by law.

What is claimed is:

1. A device comprising:
a body formed as a hand-held writing implement, the body including a writing tip adapted to mark a surface with a physical marking; and
a plurality of passive devices within the body, each one of the plurality of passive devices having a known location relative to the writing tip, and each one of the plurality of passive devices providing a characteristic signal in response to a predetermined external stimulus, the characteristic signal suitable for determining a location of the one of the plurality of passive devices.

2. The device of claim 1 further comprising a power source separate from the body that provides the predetermined external stimulus as an electromagnetic field that remotely powers the plurality of passive devices.

3. The device of claim 1 wherein the characteristic signal of each one of the plurality of passive devices includes a unique electromagnetic signature.

4. The device of claim 1 wherein the characteristic signal of each one of the plurality of passive devices includes an acoustic signature.

5. The device of claim 1 further comprising one or more remote sensors that detect the characteristic signals from the plurality of passive devices to provide sensor data.

6. The device of claim 5 further comprising a processor configured to receive the sensor data and determine a plurality of distances from the one or more remote sensors to the plurality of passive devices, the processor further configured to calculate a position of the writing tip.

7. The device of claim 5 further comprising a processor adapted to receive the sensor data and determine a position and orientation of the body.

8. The device of claim 5 wherein the one or more remote sensors include an RFID reader.

9. The device of claim 1 wherein the body includes an erasing tip on an opposing end of the body to the writing tip, the erasing tip adapted to remove the physical marking.

10. The device of claim 1 wherein the plurality of passive devices include at least one passive RFID tag.

11. The device of claim 1 further comprising an ink reservoir coupled to the writing tip to distribute ink for the physical marking.

12. The device of claim 11 wherein the writing tip includes a ball point pen tip.

13. The device of claim 1 wherein the writing tip includes a pencil tip.

14. The device of claim 1 wherein the passive devices are removably connected to the body.

15. The device of claim 1 wherein each characteristic signal encodes one or more of a distance from the writing tip, a distance from a centerline of the body, a distance from an opposing tip of the body, a code specifying whether an associated one of the passive devices is nearer to the writing tip of the opposing tip, and a unique identification code.

16. The device of claim 1 wherein one or more of the plurality of devices includes an associated memory.

17. A system comprising:
a writing surface;
a plurality of sensors arranged about the writing surface, each sensor adapted to receive a signal from one or more of a plurality of passive devices having a known location relative to a writing tip of a writing instrument, and to provide sensor data indicative of a distance to the one or more of the plurality of devices; and
a processor coupled to the plurality of sensors, the processor configured to receive the sensor data and to calculate therefrom a location of the writing tip, and the processor further configured to digitally record a position of the writing tip when the writing tip is substantially in the plane of the writing surface.

18. The system of claim 17 further comprising a remote power source that stimulates one or more of the passive devices to transmit a characteristic signal.

19. The system of claim 17 further comprising a memory to store the position of the writing tip when the writing tip is substantially in the plane of the writing surface.

20. The system of claim 17 further comprising one or more thickness sensors to measure a thickness of an object placed on the writing surface.

21. The system of claim 20 wherein the processor accounts for the thickness of the object when determining whether the writing tip is substantially in the plane of the writing surface.

22. The system of claim 17 wherein the passive devices include passive RFID tags and the sensors include an RFID reader.

23. The system of claim 17 further comprising a hand-held writing implement adapted to mark a surface with a physical marking, the hand-held writing implement containing the writing tip and the plurality of passive devices.

24. A system comprising a plurality of passive devices adapted to be removably and replaceably attached to an exterior of a hand-held writing implement that includes a writing tip adapted to mark a surface with a physical marking, each one of the plurality of passive devices having a known location relative to the writing tip, and each one of the plurality of passive devices providing a characteristic signal in response to a predetermined external stimulus, the characteristic signal suitable for determining a location of the one of the plurality of passive devices.

25. The positioning device of claim 24 wherein the hand-held writing implement includes a ball point pen.

26. The positioning device of claim 24 wherein the hand-held writing implement includes a mechanical pencil.
